(19) United States
(12) Patent Application Publication
(10) Pub. No.: US 2020/0168376 A1
(43) Pub. Date: May 28, 2020

(54) MAGNETIC POWDER, COMPRESSED POWDER CORE, METHOD OF PREPARATION THEREOF

(71) Applicant: LG ELECTRONICS INC., Seoul (KR)

(72) Inventors: Dongwon KANG, Seoul (KR); Jin Bae KIM, Seoul (KR); Joungwook KIM, Seoul (KR)

(21) Appl. No.: 16/693,603

(22) Filed: Nov. 25, 2019

(30) Foreign Application Priority Data
Nov. 26, 2018 (KR) 10-2018-0147877

(51) Int. Cl. H01F 1/147; H01F 1/22; H01F 41/02

(52) U.S. Cl. CPC H01F 1/14766; H01F 41/0246; H01F 1/22

(57) ABSTRACT

Disclosed are magnetic powders, compressed magnetic powders and a preparation method thereof. The magnetic powder contains a plate-shaped particle whose aspect ratio defined in a following relationship 1 is equal to or larger than 4: [relationship 1] aspect ratio=length of long side of plate-shaped particle/length of short side of plate-shaped particle.

### CROSS-REFERENCE TO RELATED APPLICATIONS

This application claims the priority of Korean Patent Application No. 10-2018-0147877 filed on Nov. 26, 2018, in the Korean Intellectual Property Office, the disclosure of which is hereby incorporated by reference in its entirety.

### BACKGROUND

### 1. Technical Field

The present disclosure relates to magnetic powders, compressed magnetic powders and a preparation method thereof.

### 2. Background

In general, magnetic materials are used in various devices such as inductors, motor cores, and transformer cores.

Magnetic cores, such as rotors and stators included in electrical devices were prepared by stacking, fixing, and integrating machined steel sheets into several layers.

Recently, magnetic powders subjected to high pressure molding are used to prepare cores. A method of preparing the core via the high-pressure molding of the magnetic powders has an advantage of shaping the cores into various shapes very easily.

The magnetic powder for preparing the core refers to a powder having magnetic properties when electricity is applied thereto. The magnetic powder is generally based on Fe-based soft magnetic particles. The magnetic powder may be prepared by forming an iron-based material into a powder form via a spraying method or a pulverizing method, and by treating the powder form appropriately.

The magnetic powder is typically shaped to have a spherical shape having a uniform particle diameter.

However, in order to shape the magnetic powder into the spherical shape, sophisticated conditions and complicated processes are required. As such, the process for preparing the magnetic powder into the spherical shape is sophisticated and expensive.

In addition, the core made using the spherical powder has a problem in that durability thereof is poor because a tissue thereof is not dense.

In addition, a technique related to a mixed powder core in which crystalline powders and amorphous powders are mixed with each other is well known. The mixed powder core may be used in electrical and electronic components such as inductors. However, a high temperature sintering process cannot be applied to the mixed powder core due to differences between high temperature properties of the crystalline powder and the amorphous powder contained in the mixed powder core. Accordingly, the mixed powder core may not be used in a motor that requires strong durability such as resistance to vibration.

### SUMMARY

One aspect of the present disclosure is to provide a novel magnetic powder that may be prepared at a low cost and have improved magnetic flux density.

Further, another aspect of the present disclosure is to provide a novel magnetic powder for preparation of a motor core having highly dense tissue and high strength.

Furthermore, another aspect of the present disclosure is to provide a method to easily prepare a new magnetic powder at a low cost.

Other aspects and advantages of the present disclosure as not mentioned above may be understood from following descriptions and more clearly understood from embodiments of the present disclosure. Further, it will be readily appreciated that the aspects and advantages of the present disclosure may be realized by features and combinations thereof as disclosed in the claims.

In order to provide a new magnetic powder that may be prepared at a low cost and have improved magnetic flux density compared to a conventional magnetic powder, a magnetic powder according to the present disclosure contains a plate-shaped particle whose aspect ratio defined in a following relationship 1 is equal to or larger than 4:

aspect ratio=length of long side of plate-shaped particle/length of short side of plate-shaped particle. [relationship 1]

In order to provide a novel magnetic powder used to prepare a motor core having highly dense tissue and high strength, a magnetic powder according to the present disclosure may further contain a spherical particles having a diameter of 1 μm or smaller.

In addition, in order to provide a method for easily preparing a new magnetic powder at a low cost, a preparation method of magnetic powders according to the present disclosure may include converting a slurry containing a magnetic raw material into droplets; and spraying the droplets onto a rotating plate to prepare plate-shaped particles.

Effects of the present disclosure may be as follows but may not be limited thereto.

The magnetic powder according to the present disclosure may contain a plate-shaped particle having a specific aspect ratio and thus may be prepared at a low cost, and may have improved magnetic flux density.

Furthermore, the magnetic powder according to the present disclosure may further contain a spherical particle having a diameter of 1 μm or smaller, thereby enabling the preparation of a motor core having a highly dense tissue and having a high strength.

Furthermore, the preparation method of the magnetic powders according to the present disclosure may prepare the plate-shaped particles in a relatively simple manner, thereby easily preparing the new magnetic powder at a low cost.

### BRIEF DESCRIPTION OF DRAWINGS

FIG. 1 shows a SEM image of plate-shaped particles in magnetic powders in accordance with the present disclosure.

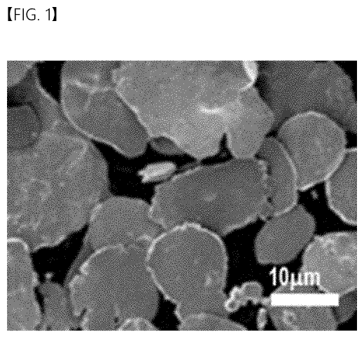

FIG. 2 schematically illustrates an apparatus for preparing plate-shaped particles in accordance with the present disclosure.

FIGS. 3(a) and 3(b) are schematic diagrams illustrating a compression and sintering process in preparing a compressed powder core in accordance with the present disclosure.

### DETAILED DESCRIPTIONS

For simplicity and clarity of illustration, elements in the figures are not necessarily drawn to scale. The same reference numbers in different figures denote the same or similar elements, and as such may perform similar functionality. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers. It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a magnetic powder, a compressed powder core, and a preparation method thereof according to the present disclosure will be described in detail.

<Magnetic Powder>

The magnetic powder according to the present disclosure contain a plate-shaped particle whose an aspect ratio as defined in a following relationship 1 is equal to or larger than 4:

aspect ratio=length of long side of plate-shaped particle/length of short side of plate-shaped particle. [relationship 1]

The magnetic powder containing the plate-shaped particle has a shape magnetic anisotropy compared to that containing a spherical particle. Accordingly, the magnetic powders containing the plate-shaped particles may have improved magnetic flux density when aligned in a plane direction.

The plate-shaped particle according to the present disclosure may have an aspect ratio of about 4 or greater. When the aspect ratio of the plate-shaped particle is smaller than 4, uniformity of particle diameters may be increased, which may cause a problem in that a desired shape magnetic anisotropy may not be achieved.

A material of the magnetic powder according to the present disclosure is not particularly limited. However, the plate-shaped particle may be preferably made of a crystalline material so that the magnetic powder according to the present disclosure may be applied to the motor core.

In one example, the plate-shaped particle may be made of at least one selected from a group consisting of pure iron, carbonyl iron, Fe—Si—Cr-based alloy, Fe—Ni-based alloy, Fe—Co-based alloy, Fe—V-based alloy, Fe—Al-based alloy, Fe—Si-based alloy, and Fe—Si—Al-based alloy.

In one example, the magnetic powder according to the present disclosure may contain a predefined amount of spherical particles having a small diameter so as to provide a motor core having a dense tissue and high strength.

The spherical particles may fill a portion of an empty space generated when the plate-shaped particles are stacked in a plane direction.

The spherical particle may have a diameter of 1 μm or smaller, and more preferably 0.5 μm or smaller. When the diameter of the spherical particle exceeds 1 μm, this may hinder the alignment of the plate-shaped particles in a plane direction.

<Preparation Method of Magnetic Powder>

As mentioned above, the magnetic powder according to the present disclosure contains plate-shaped particles. The present disclosure may provide a method to easily prepare the plate-shaped particles at a low cost.

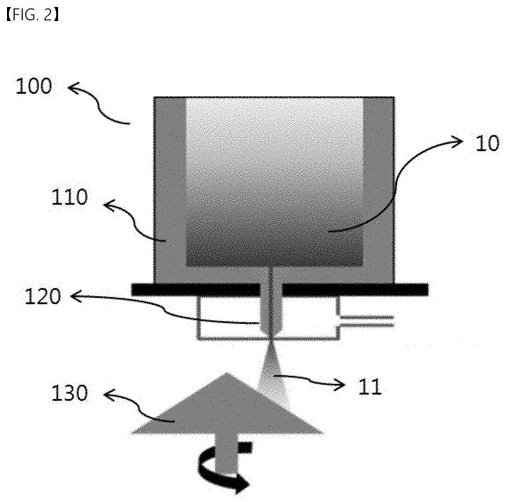

Referring to FIG. 2, the preparation method of the magnetic powder according to the present disclosure may include converting slurry 10 containing magnetic raw material into droplets 11; and spraying the droplets 11 onto a rotating plate 130 to prepare a plate-shaped particle.

First, the preparation method of the magnetic powder according to the present disclosure includes converting the slurry 10 containing the magnetic raw material into the droplets 11.

The raw material is not particularly limited. In one example, the raw material may include at least one selected from a group consisting of pure iron, carbonyl iron, Fe—Si—Cr-based alloy, Fe—Ni-based alloy, Fe—Co-based alloy, Fe—V-based alloy, Fe—Al-based alloy, Fe—Si-based alloy, and Fe—Si—Al-based alloy.

Referring to FIG. 2, in one embodiment according to the present disclosure, the slurry 10 may be introduced into a furnace 110 and then the slurry 10 may be converted into the droplets 11 through an outlet 120.

In another example, a preparation method of the slurry including the raw material, a method of converting the slurry into the droplets, and a method of spraying the droplets are not particularly limited, and may be performed using various known methods.

Next, the preparation method of the magnetic powder according to the present disclosure includes spraying the droplets 11 onto the rotating plate 130 to form a plate-shaped particle.

The droplets 11 may be sprayed onto the rotating plate 130. The droplets 11 may solidify on the plate 130 and may be converted into the plate-shaped particles.

In one example, the plate may have a predefined inclination. A degree of the inclination may be suitably selected as needed.

<Compressed Powder Core>

Next, the compressed powder core according to the present disclosure may be prepared by press-molding and sintering the magnetic powder containing the plate-shaped particles as described above. As described above, the plate-shaped particle has an aspect ratio of 4 or larger defined by the following relationship 1.

aspect ratio=length of long side of plate-shaped particle/length of short side of plate-shaped particle. [relationship 1]

The compressed powder core according to the present disclosure may be prepared by press-molding and sintering a stack of plate-shaped particles stacked in a plane direction, and thus may have a very dense tissue and excellent strength.

As described above, the material of the magnetic powder according to the present disclosure is not particularly limited. The material of the magnetic powder may be preferably made of a crystalline material so that the magnetic powder according to the present disclosure may be applied to the motor core.

In one example, the plate-shaped particle may be made of at least one selected from a group consisting of pure iron, carbonyl iron, Fe—Si—Cr-based alloy, Fe—Ni-based alloy, Fe—Co-based alloy, Fe—V-based alloy, Fe—Al-based alloy, Fe—Si-based alloy, and Fe—Si—Al-based alloy.

In one example, the magnetic powder according to the present disclosure may contain a predefined amount of spherical particles having a small diameter so as to provide a motor core having a dense tissue and high strength.

The spherical particles may fill a portion of an empty space generated when the plate-shaped particles are stacked in a plane direction.

The spherical particle may have a diameter of 1 μm or smaller, and more preferably 0.5 μm or smaller. When the diameter of the spherical particle exceeds 1 μm, this may hinder the alignment of the plate-shaped particles in a plane direction.

<Preparation Method of Compressed Powder Core>

Next, the preparation method of the compressed powder core according to the present disclosure may include pressing the magnetic powder containing the plate-shaped particle having an aspect ratio aspect ratio of 4 or greater as defined in the following relationship 1, to thereby obtain a molded product, and sintering the molded product:

aspect ratio=length of long side of plate-shaped particle/length of short side of plate-shaped particle. [relationship 1]

The preparation method of the compressed powder core according to the present disclosure may include pressing the magnetic powder containing the plate-shaped particle to thereby obtain the molded product. The molded product may be a compressed powder core.

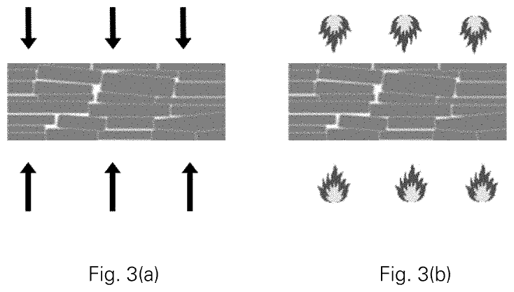

Referring to FIG. 3(a), it may be seen that the plate-shaped particles are arranged in a plane direction and are subjected to the pressure forming to prepare the molded product.

The magnetic powder in this process may use the same magnetic powder according to the present disclosure. The magnetic powder may preferably contain a crystalline material, and may further contain the spherical particle having a diameter of 1 μm or smaller.

Next, the preparation method of the compressed powder core according to the present disclosure may include sintering the molded product.

Referring to FIG. 3(b), the press-molded product may be sintered by applying high temperature heat thereto. The high temperature sintering may be performed within a temperature range of 1100 to 1400° C. for 1 to 3 hours. The sintering time duration or temperature is not particularly limited. The high temperature sintering according to the present disclosure may employ a known sintering method.

Hereinafter, specific examples of the present disclosure will be described below.

### EXAMPLES

### 1. Present Example 1

(1) Preparation of Magnetic Powder

A crystalline magnetic material composed of carbonyl iron was prepared. A slurry was obtained by mixing 97 parts by mass of the magnetic material, 2.5 parts by mass of an insulating binder composed of an acrylic resin and a phenol resin, and 0.5 parts by mass of a lubricant composed of zinc stearate with water as a solvent.

The slurry as obtained was sprayed onto the plate using an apparatus 100 shown in FIG. 2 to obtain plate-shaped particles. The aspect ratio of each of the plate-shaped particles was in a range of 5 to 6. The aspect ratio was measured as an average value of the aspect ratios of five particles randomly extracted from the SEM image.

(2) Press-Molding

The obtained magnetic powders were filled into a mold and pressure-molded therein at a surface pressure of 1 to 2 GPa to obtain a molded product having a ring shape having an outer diameter of 20 mm, an inner diameter of 12 mm and a thickness of 3 mm

(3) Heat Treatment and Sintering

The obtained molded product was positioned in a furnace containing nitrogen airflow atmosphere. A temperature of the furnace was raised from room temperature at a rate of 2° C. per minute to 600° C. Then, the obtained molded product was subjected to the heat treatment for 2 hours. Thereafter, the temperature was increased at a rate of 2° C. per minute to at 1300° C. Then, the molded product was subjected to the heat treatment for 2 hours at 1300° C., thereby to obtain a compressed powder core.

### 2. Present Example 2

80% of the slurry of Present Example 1 was composed of plate-shaped particles while 20% thereof was composed of spherical particles to obtain the mixed magnetic powders in which the plate-shaped particles and spherical particles were mixed with each other. Then, a compressed powder core according to Present Example 2 was obtained by applying the same molding, heat treatment, and sintering processes as in Present Example 1 to the mixed magnetic powders.

In Present Example 2, the spherical particles were obtained from a crystalline magnetic material made of carbonyl iron and were prepared using a spray dryer apparatus.

### 3. Comparative Example 1

An entirety of the slurry of Comparative Example 1 was composed of the magnetic powders made of spherical particles. A compressed powder core according to Comparative Example 1 was obtained by applying the same molding and sintering process as in Present Example 1 to the magnetic powders.

The spherical particles were obtained from a crystalline magnetic material made of carbonyl iron and were prepared using a spray dryer apparatus.

<Measurement of Magnetic Properties>

Magnetic flux densities of the compressed powder cores according to Present Examples 1 and 2 and Comparative Example 1 as obtained were measured. The magnetic flux density of each core was measured by obtaining a hysteresis curve value using a hysteresis curve meter (AE TECHRON B-H curve tracer) and by calculating the magnetic flux density from the hysteresis curve.

Each of Present Examples 1 and 2 exhibited a magnetic flux density of 1.8 T tesla, while Comparative Example 1 exhibited a magnetic flux density of 1.7 T tesla. Accordingly, it may be seen that the core using the magnetic powder according to the present disclosure has improved magnetic flux density compared to the core using the conventional magnetic powder.

It is to be understood that the aforementioned embodiments are illustrative in all respects and not restrictive. Further, the scope of the present disclosure will be indicated by the following claims rather than the aforementioned description. Further, the meaning and scope of the claims will be indicated by the claims. Also, all changes and modifications derived from the equivalent concept should be construed as being included in the claims.

What is claimed is:

1. A magnetic powder comprising:
a plate-shaped particle whose aspect ratio defined in a following relationship 1 is equal to or larger than 4:
aspect ratio=length of long side of plate-shaped particle/length of short side of plate-shaped particle. [relationship 1]

2. The magnetic powder of claim 1, wherein the plate-shaped particle is made of at least one selected from a group consisting of pure iron, carbonyl iron, Fe—Si—Cr-based alloy, Fe—Ni-based alloy, Fe—Co-based alloy, Fe—V-based alloy, Fe—Al-based alloy, Fe—Si-based alloy, and Fe—Si—Al-based alloy.

3. The magnetic powder of claim 1, wherein the magnetic powder includes a spherical particle having a diameter of 1 μm or smaller.

4. A method for preparing a magnetic powder, the method comprising:
converting slurry containing a magnetic raw material into droplets; and
spraying the droplets onto a rotating plate to form plate-shaped particles.

5. The method of claim 4, wherein the raw material includes at least one selected from a group consisting of pure iron, carbonyl iron, Fe—Si—Cr-based alloy, Fe—Ni-based alloy, Fe—Co-based alloy, Fe—V-based alloy, Fe—Al-based alloy, Fe—Si-based alloy, and Fe—Si—Al-based alloy.

6. The method of claim 4, wherein the rotating plate is inclined in a predefined angle.

7. A compressed powder core obtained by press-molding and sintering magnetic powder, wherein the magnetic powder contains a plate-shaped particle whose aspect ratio defined in a following relationship 1 is equal to or larger than 4:
aspect ratio=length of long side of plate-shaped particle/length of short side of plate-shaped particle. [relationship 1]

8. The compressed powder core of claim 7, wherein the magnetic powder includes a spherical particle having a diameter of 1 μm or smaller.

9. A method for preparing a compressed powder core, the method comprising:
press-molding magnetic powder to form a molded product; and
sintering the molded product,
wherein the magnetic powder includes a plate-shaped particle whose aspect ratio defined in a following relationship 1 is equal to or larger than 4:
aspect ratio=length of long side of plate-shaped particle/length of short side of plate-shaped particle. [relationship 1]
